(19) United States
(12) Patent Application Publication
(10) Pub. No.: US 2026/0349099 A1
(43) Pub. Date: Nov. 5, 2026

(54) CALIBRATION METHOD OF CALIBRATING A LASER SCANNING SYSTEM, CALIBRATION SYSTEM, AND NON-TRANSITORY STORAGE MEDIA

(71) Applicant: HON HAI PRECISION INDUSTRY CO., LTD., New Taipei (TW)

(72) Inventor: CHUN-WEI LIU, New Taipei (TW)

(21) Appl. No.: 19/662,040

(22) Filed: Apr. 29, 2026

(30) Foreign Application Priority Data
Apr. 30, 2025 (CN) 202510569105.7

(51) Int. Cl. G01S 7/497; G01S 7/48; G01S 17/08

(52) U.S. Cl. CPC G01S 7/4972; G01S 7/4802; G01S 7/4808; G01S 17/08

(57) ABSTRACT

A calibration method of calibrating a laser scanning system including a plurality of lidars, the calibration method includes: aligning the lidars with a target object sequentially and obtaining a first point cloud data of the target object by each lidar; comparing the first point cloud data obtained by the lidars and selecting the first point cloud data of a lidar of the lidars as reference point cloud data; calibrating the first point cloud data obtained by each of other lidars of the plurality of lidars based on the reference point cloud data; obtaining second point cloud data of the target object by each of the plurality of lidars in combination of calibrated first point cloud data; fusing the second point cloud data obtained by the plurality of lidars into fused point cloud data. A calibration system and a non-statant storage medium are also provided.

### FIELD

The subject matter herein generally relates to autonomous driving field, especially a calibration method of calibrating a laser scanning system, a calibration system, and a non-transitory storage media.

### BACKGROUND

Lidar systems hold promising applications in remote sensing and autonomous driving fields. While high-end lidars with wide field-of-view (FoV) capabilities are expensive, a cost-effective alternative involves combining multiple low-FoV lidar units and fusing their point cloud to achieve an expanded scanning range. However, this multi-lidar fusion approach often suffers from alignment errors during assembly, leading to spatial offsets between the actual fused point cloud data and the ideal/theoretically correct point cloud alignment.

### BRIEF DESCRIPTION OF THE DRAWINGS

Implementations of the present disclosure will now be described, by way of embodiment, with reference to the attached figures, wherein:

FIG. 1 is a schematic diagram of a calibration system according to an embodiment of the present disclosure.

FIG. 2 is a flowchart of a calibration method of calibrating a laser scanning system according to an embodiment of the present disclosure.

FIG. 3 is an embodiment of a flowchart of block S100 of the flow chart shown in FIG. 2.

FIG. 4 is an embodiment of a flowchart of block S200 of the flow chart shown in FIG. 2.

FIG. 5 is an embodiment of a flowchart of block S300 of the flow chart shown in FIG. 2.

FIG. 6 is an embodiment of a flowchart of block S400 of the flow chart shown in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

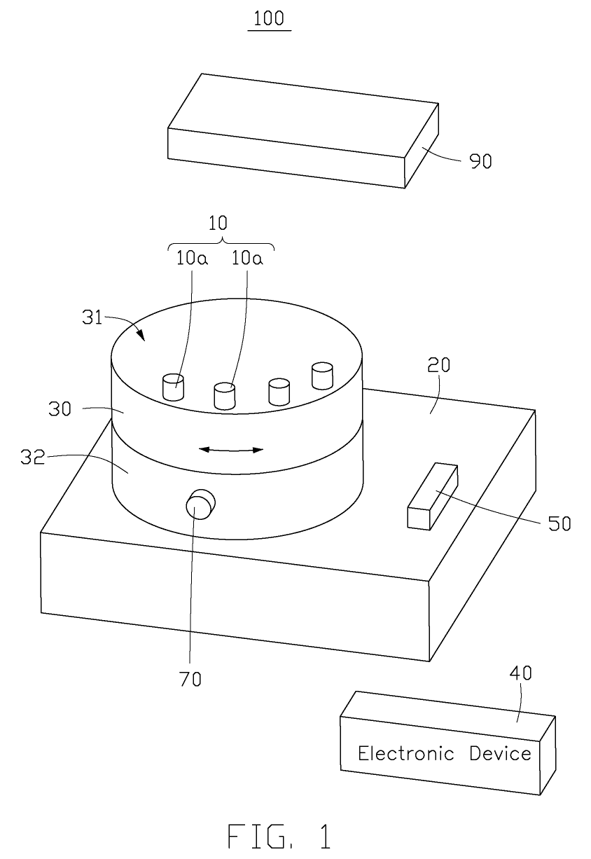

FIG. 1 shows a calibration system 100 according to an embodiment of the present disclosure, which is applied with a calibration method to calibrate a laser scanning system 10. The laser scanning system 10 includes a plurality of lidars 10a. The calibration system 100 includes a rotating device 30, a level 50, a laser rangefinder 70, and a base 90. The rotating device 30 and the level 50 are on a same surface of the base 90 and are spaced apart from each other. The rotating device 30 includes a top surface 31 and side surfaces 32 that are perpendicular to each other. The top surface 31 is used to carry the lidars 10a, and the laser rangefinder 70 is fixed on the side surface 32. The rotating device 30 can rotate around an axis perpendicular to the top surface to drive the laser scanning system 10 to rotate. The lidars 10a on the top surface 31 of the rotating device 30 are spaced apart from each other. The level 50 is used to detect whether the lidars 10a and a target object 90 are on a same horizontal plane. The laser rangefinder 70 is used to detect a distance between each lidar 10a and the target object 90.

The rotating device 30 may include a carrier (not shown) and a driving device (not shown). The lidars 10a can be arranged on the carrier, and the driving device is used to rotate the carrier. In other embodiments, the rotating device 30 can be manually rotated or driven by a motor. A shape of the carrier or a speed of the motor is not limited. In other embodiments, the laser rangefinder 70 can be replaced by a sonar rangefinder or a standard scale to achieve a same function.

Each lidar 10a has a specific field of view. When the laser scanning system 10 is working, point cloud data collected by the lidars 10a can be fused, so that a total field of view of the laser scanning system 10 equals a sum of the field of view of the lidars 10a. In one embodiment, the laser scanning system 10 includes four laser lidars 10a, each with a field of view angle of 30 degrees, resulting in the total field of view angle of 120 degrees for the laser scanning system 10.

The calibration system 100 also includes an electronic device 40, which can be connected to each laser lidar 10a through wired or wireless means to process point cloud data obtained by each lidar 10a. In the embodiment as shown in FIG. 1, the electronic device 40 is connected to each laser lidar 10a through a wireless mean. The electronic device 40 can also be electrically connected to the rotating device 30 for controlling a rotation operation of the rotating device 30.

The calibration system 100 provided in this embodiment uses a calibration method to sequentially calibrate each lidar 10a and calibrate the laser scanning system 10, which is beneficial for calibrating each lidar 10a and output results of the laser scanning system 10, reducing an error of fusing point cloud data in the laser scanning system 10, and easily fusing point cloud data from multiple laser lidars 10a, thereby reducing a cost.

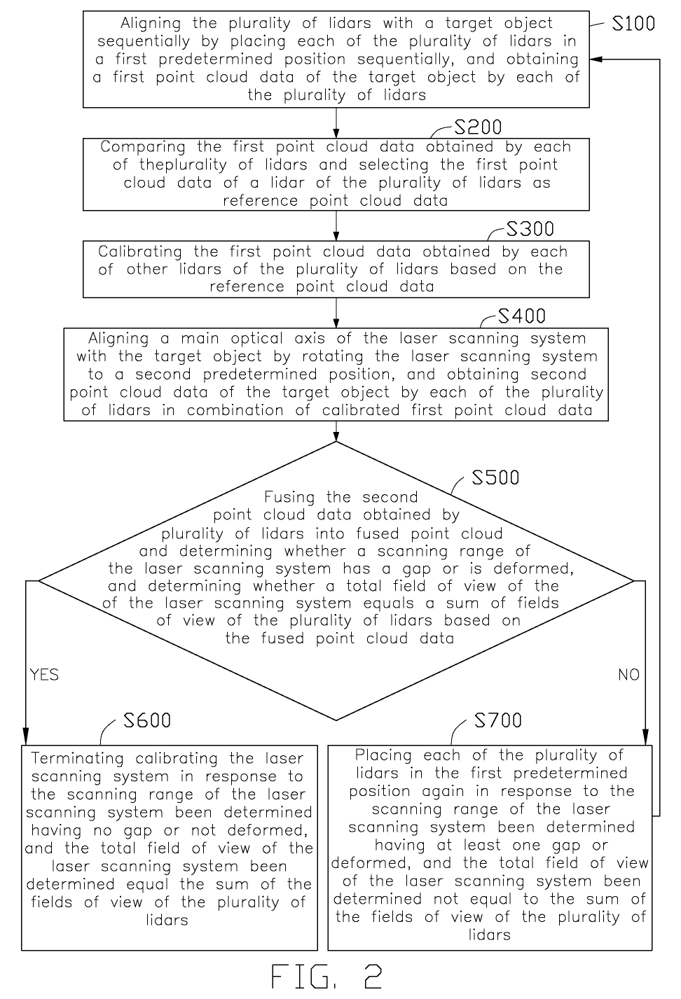

FIG. 2 shows a flowchart of an example of the calibration method of a laser scanning system provided in the present embodiment, which includes blocks S100 to S600. The method can be applied to the calibration system 100. The method described below can be carried out using the configurations illustrated in FIG. 1, for example, and various elements of the figure are referenced in explaining example method. According to different requirements, the order of the blocks is illustrative only and the order of the blocks can be changed. Additional blocks can be added or fewer blocks can be utilized without departing from this disclosure.

At block S100, the plurality of lidars 10a are aligned with the target object 90 sequentially by placing the plurality of lidars 10a in a first predetermined position sequentially , and a first point cloud data of the target object 90 is obtained by each of the plurality of lidars 10a.

At block S200, the first point cloud data obtained by each of the plurality of lidars 10a are compared to select the first point cloud data of one of the plurality of lidars 10a as reference point cloud data.

At block S300, the first point cloud data obtained by the other lidars 10a of the plurality of lidars 10a are calibrated based on the reference point cloud data.

At block S400, a main optical axis of the laser scanning system 100 is aligned with the target object 90 by rotating the laser scanning system 100 to a second predetermined position, and second point cloud data of the target object 90 is obtained by each of the plurality of lidars 10a in combination of calibrated first point cloud data.

At block S500, the second point cloud data obtained by the plurality of lidars 10a are fused into fused point cloud data, and the electronic device 40 is used to determine whether a scanning range of the laser scanning system 100 a has a gap or is deformed, and determine whether a total field of view of the laser scanning system100 equals a sum of fields of view of the plurality of lidars 10a based on the fused point cloud data.

At block S600, calibrating the laser scanning system is terminated in response to the scanning range of the laser scanning system 100 been determined having no gap or not deformed, and the total field of view of the laser scanning system 100 been determined equal the sum of the fields of view of the plurality of lidars 10a.

At block S700, the plurality of lidars 10a are placed in the first predetermined position again and the calibration system 100 executes the calibration method of the laser scanning system from block S100 to block S600 again in response to the scanning range of the laser scanning system 100 been determined having at least one gap or deformed, and the total field of view of the laser scanning system 100 been determined not equal to the sum of the fields of view of the plurality of lidars 10a.

The calibration method for the laser scanning system provided in the embodiments of the present disclosure sequentially calibrates first point cloud data obtained by each lidar 10a and obtain second point cloud data according to calibrated first point cloud data. The second point cloud data of the lidars 10a are fused into fused point cloud data, which is beneficial for calibrating the output results of the laser scanning system 100, reducing the error of fusing point cloud data of the laser scanning system 100, and easily fusing point cloud data of the lidars 10a, thereby expanding the field of view and reducing the cost of the laser scanning system 100.

The block S100 further includes blocks S001 and S002.

At block S001, the plurality of lidars are placed on a rotating device and are arranged at equal intervals.

At block S002, a first distance between the laser scanning system and the target object is established.

At block S001, the lidars are arranged at equal intervals to minimize errors in the fused point cloud data obtained by the lidars. In this embodiment, the rotating device 30 can rotate at a constant speed. In other embodiments, the rotating device can be a platform driven by a motor that can rotate at a constant speed, or other devices that can rotate at a constant speed. At block S002, the first distance is a pre-established distance and equals a distance from the first predetermined position to the target object 90. In other embodiments, the first distance does not equal to the distance from the first predetermined position to the target object 90. After block S002, the electronic device 40 further used to calculate a minimum width based on the first distance, a number of the lidars 10a, and the field of view of each lidar 10a, wherein an actual width of the target object 90 should be greater than or equal to the minimum width.

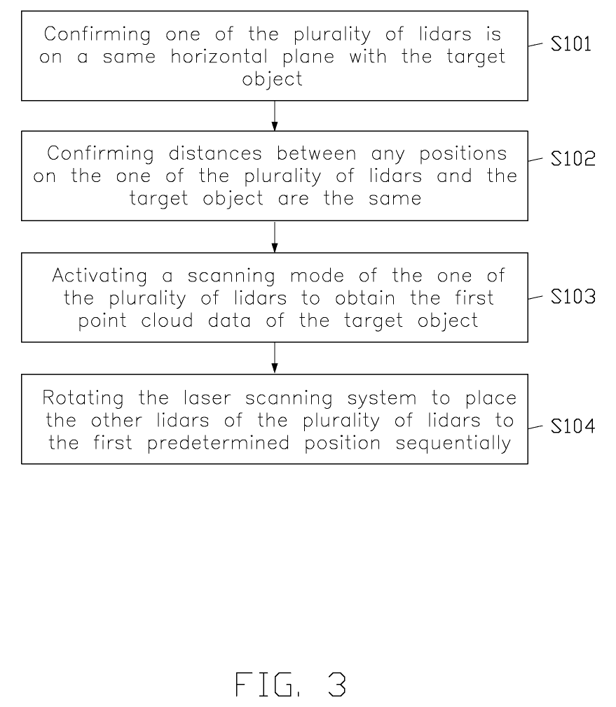

Referring to FIG. 3, in at least one embodiment, block S100 includes blocks S101 to S104.

At block S101, each of the plurality of lidars is confirmed to be on a same horizontal plane with the target object.

At block S102, distances between any positions on the one of the plurality of lidars and the target object are confirmed to be the same.

At block S103, a scanning mode of the one of the plurality of lidars is activated to obtain the first point cloud data of the target object.

At block S104, the laser scanning system is rotated to place the other lidars of the plurality of lidars to the first predetermined position sequentially.

At block S101, one of the lidars 10a is confirmed to be on a same horizontal plane with the target object 90 by the level 50. In this embodiment, the first predetermined position is the same as the second predetermined position. In other embodiments, the first predetermined position may also be different from the second predetermined position.

In this embodiment, at block S102, the laser rangefinder 70 is used to confirm that the distances between any positions of the one lidar 10a and the target object 90 are the same. In other embodiments, the distances can also be confirmed through ranging devices such as sonar rangefinders, scales, or infrared rangefinders. At block S103, the first point cloud data is the three-dimensional point cloud data of the target object 90. At block S104, the remaining lidars are placed in the first predetermined position sequentially. That is, at block S104, the laser scanning system 100 is rotated to place a next one laser 10a to the first predetermined position, and the next one laser 10a is activated to obtain the first point cloud data of the target object 2.

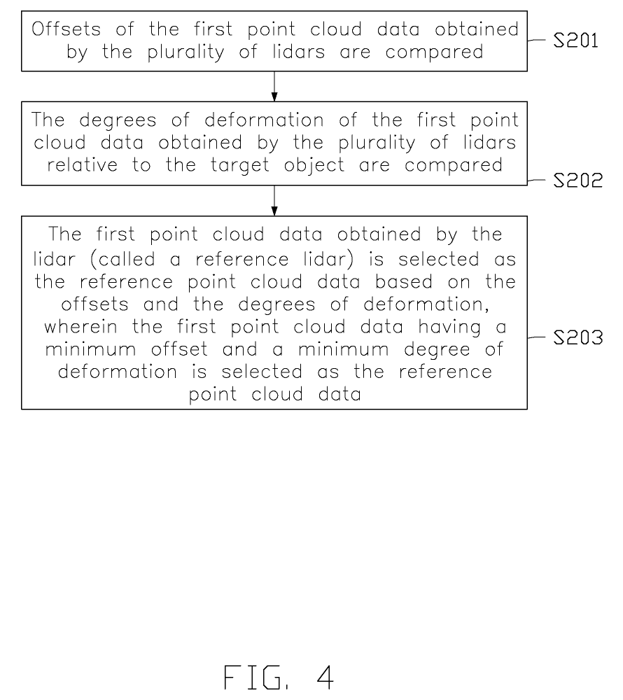

As shown in FIG. 4, in at least one embodiment, block S200 includes blocks S201 to S203.

At block S201, offsets of the first point cloud data obtained by the plurality of lidars are compared.

At block S202, the degrees of deformation of the first point cloud data obtained by the plurality of lidars relative to the target object are compared.

At block S203, the first point cloud data obtained by the lidar (called a reference lidar) is selected as the reference point cloud data based on the offsets and the degrees of deformation, wherein the first point cloud data having a minimum offset and a minimum degree of deformation is selected as the reference point cloud data.

At block S201 and block S202, the offset and the degree of deformation of the first point cloud data are compared to improve an accuracy of the reference point cloud. An order of block S201 and block S202 can be changed. At block S203, the reference point cloud data has a smaller offset and a smaller degree of deformation compared to the other first point cloud data.

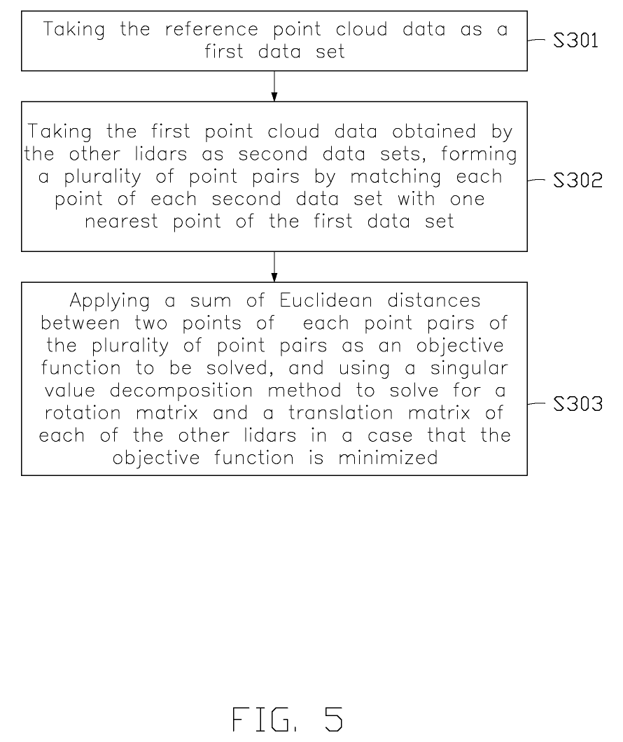

As shown in FIG. 5, block S300 includes blocks S301 to S303.

At block S301, the reference point cloud data is defined as a first data set.

At block S302, the first point cloud data obtained by the other lidars is defined as second data sets and each point of each second data set is matched with one nearest point of the first data set to form a plurality of point pairs.

At block S303, a sum of Euclidean distances between two points of each of the plurality of point pairs is applied as an objective function to be solved, and a singular value decomposition method is used to solve for a rotation matrix and a translation matrix of each of the other lidars in case that the objective function is minimized.

At block S301, the reference point cloud data is defined as a first data point set P. At block S302, the remaining first point cloud data are respectively referred as second data point set Q1, Q2, and Q3. Each point of each second data set Q1, Q2, and Q3 is matched with one nearest point of the first data set P to form a plurality of point pairs. That is, each point pair includes one point from the first data set P and one point from second data set Q1, Q2, or Q3. At block S303, a sum of Euclidean distances between two points within each point pair is used as an objective function to be solved, and a singular value decomposition method is used to solve for the rotation matrix R and the translation matrix T of each of the other lidars 10a when the objective function is minimized.

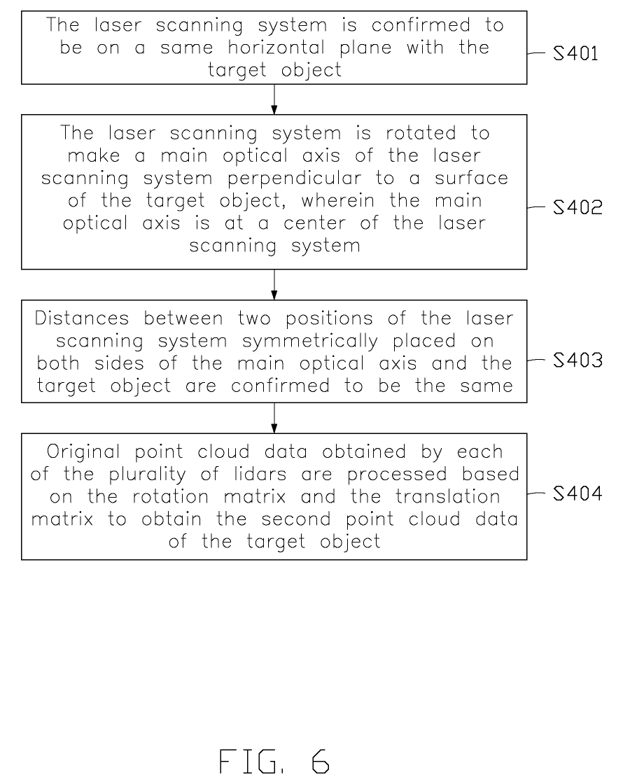

Referring to FIG. 6, llock S400 includes blocks S401 to S404.

At block S401, the laser scanning system is confirmed to be on a same horizontal plane with the target object.

At block S402, the laser scanning system 100 is rotated to make a main optical axis of the laser scanning system 100 perpendicular to a surface of the target object 2, wherein the main optical axis is at a center of the laser scanning system 100.

At block S403, distances between two positions of the laser scanning system 100 symmetrically placed on both sides of the main optical axis and the target object are confirmed to be the same.

At block S404, original point cloud data obtained by each of the plurality of lidars 10a are processed based on the rotation matrix and the translation matrix to obtain the second point cloud data of the target object 2.

At block S401, the level 50 is used to confirm that the laser scanning system is on the same horizontal plane with the target object 90. At block S402, the main optical axis is located at the center position of the laser scanning system 100. If the laser scanning system 100 includes four lidars 10a, the center position is located on a centerline of two lidars 10 in the middle. If the laser scanning system 100 includes five lidars 10a, the center position is located on a centerline of the lidar 10a in the middle. In this embodiment, at block S403, the distances between two symmetrical positions of the laser scanning system 100 on both sides of the main optical axis and the target object 90 are confirmed to be the same by the laser rangefinder 70. In other embodiments, the distances between two symmetrical positions of the laser scanning system 100 on both sides of the main optical axis and the target object 90 can also be confirmed to be the same by ranging devices such as sonar rangefinders, scales, or infrared rangefinders.

At block S404, the lidars 10a are placed to the second predetermined position sequentially and are used to obtain original point cloud data sequentially, the original point cloud data are calibrated by the electronic device 40 based on the rotation matrix R and the translation matrix T to obtain the second point cloud data of the target object 90.

At block S500, the second point cloud data obtained by the lidars 10a are fused into fused point cloud data, and the electronic device 40 is used to determine whether there is a gap or a deformation of a scanning range of the laser scanning system and whether a total field of view of the laser scanning system equals a sum of fields of view of the plurality of lidars based on the fused point cloud data. In other embodiments, the gap, the deformation and the field of view can be determined by naked eye.

The electronic device 40 includes a storage device and a processor connected to the storage device.

The storage device may be used to store program codes and various data of computer programs. For example, the storage device may be used to store a data processing system installed in the electronic device 40 and implement the running of stored programs or data during an operation of the electronic device 40. The storage device may include a non-volatile storage medium and a volatile storage medium. The storage device may include a hard disk, a memory, a plug-in hard disk, a smart memory card (SMC), a Secure Digital (SD) card, a flash card, at least one disk storage device, a flash memory device, or other storage medium.

The processor provides computing and control capabilities of the electronic device 40. For example, the processor 403 executes a computer program stored in the storage device to implement the blocks in the calibration method of FIGS. 2-4.

The processor may be a central processing unit (CPU) or other general-purpose processor, a digital signal processor (DSP), a disclosure specific integrated circuit (ASIC), a field-programmable gate array (FPGA) or other programmable logic device, a discrete gate, or a transistor logic device, or a discrete hardware component, etc. The processor may be a microprocessor or any conventional processor.

Details of the processor executing the computer-readable instructions stored in the storage device to implement data processing can refer to the description of the calibration methods in FIGS. 2-4, and are not repeated here.

The present disclosure also provides a computer-readable storage medium. The computer-readable storage medium stores a computer program, the computer program includes instructions. The instructions are executed by a processor of an electronic device to implement the calibration method.

The computer-readable storage medium may be an internal storage device of the electronic device described above, such as a hard disk or a memory of the electronic device. The computer-readable storage medium may also be an external storage device of the electronic device, such as a plug-in hard disk, a smart memory card (SMC), a secure digital (SD), and a flash card in the electronic device.

Finally, it should be noted that the above embodiments are only used to illustrate the technical solution of the present disclosure and not to limit the present disclosure. Although the present disclosure has been described in detail with reference to preferred embodiments, one ordinary skill in the art should understand that the technical solution of the present disclosure can be modified or equivalent replaced without departing from the spirit and scope of the technical solution of the present disclosure.

What is claimed is:

1. A calibration method of calibrating a laser scanning system comprising a plurality of lidars, the calibration method comprising:
aligning the plurality of lidars with a target object sequentially by placing each of the plurality of lidars in a first predetermined position sequentially, and obtaining a first point cloud data of the target object by each of the plurality of lidars;
comparing the first point cloud data obtained by each of the plurality of lidars and selecting the first point cloud data of a lidar of the plurality of lidars as reference point cloud data;
calibrating the first point cloud data obtained by each of other lidars of the plurality of lidars based on the reference point cloud data;
aligning a main optical axis of the laser scanning system with the target object by rotating the laser scanning system to a second predetermined position, and obtaining second point cloud data of the target object by each of the plurality of lidars in combination of calibrated first point cloud data;
fusing the second point cloud data obtained by the plurality of lidars into fused point cloud data, determining whether a scanning range of the laser scanning system has a gap or is deformed, and determining whether a total field of view of the laser scanning system equals a sum of fields of view of the plurality of lidars based on the fused point cloud data; and
terminating calibrating the laser scanning system in response to the scanning range of the laser scanning system been determined having no gap or not deformed, and the total field of view of the laser scanning system been determined equal the sum of the fields of view of the plurality of lidars.

2. The calibration method according to claim 1, further comprising: placing each of the plurality of lidars in the first predetermined position again in response to the scanning range of the laser scanning system been determined having at least one gap or deformed, and the total field of view of the laser scanning system been determined not equal to the sum of the fields of view of the plurality of lidars.

3. The calibration method according to claim 1, before placing each of the plurality of lidars in the first predetermined position sequentially, the method further comprising:
placing the plurality of lidars on a rotating device and arranging the plurality of lidars at equal intervals; and
establishing a first distance between the laser scanning system and the target object.

4. The calibration method according to claim 3, after establishing a first distance between the laser scanning system and the target object, the method further comprising: calculating a minimum width of the target object based on the first distance, a number of the plurality of lidars, and the field of view of each of the plurality of lidars, wherein an actual width of the target object is greater than or equal to the minimum width.

5. The calibration method according to claim 1, wherein placing each of the plurality of lidars in a first predetermined position sequentially comprises:
confirming one of the plurality of lidars is on a same horizontal plane with the target object;
confirming distances between any positions on the one of the plurality of lidars and the target object are the same;
activating a scanning mode of the one of the plurality of lidars to obtain the first point cloud data of the target object; and
rotating the laser scanning system to place the other lidars of the plurality of lidars to the first predetermined position sequentially.

6. The calibration method according to claim 1, wherein comparing the first point cloud data obtained by each the plurality of lidars and selecting the first point cloud data of the lidar of the plurality of lidars as the reference point cloud data comprises:
comparing offsets of the first point cloud data obtained by the plurality of lidars;
comparing degrees of deformation of the first point cloud data obtained by the plurality of lidars relative to the target object; and
selecting the first point cloud data obtained by the lidar as the reference point cloud data based on the offsets and the degrees of deformation.

7. The calibration method according to claim 1, wherein calibrating the first point cloud data obtained by each of the other lidars of the plurality of lidars based on the reference point cloud data comprises:
taking the reference point cloud data as a first data set;
taking the first point cloud data obtained by the other lidars as second data sets, forming a plurality of point pairs by matching each point of each second data set with one nearest point of the first data set; and
applying a sum of Euclidean distances between two points of each point pairs of the plurality of point pairs as an objective function to be solved, and using a singular value decomposition method to solve for a rotation matrix and a translation matrix of each of the other lidars in a case that the objective function is minimized.

8. The calibration method according to claim 7, wherein calibrating the first point cloud data obtained by each of the other lidars of the plurality of lidars based on the reference point cloud data comprises:
processing original point cloud data obtained by each of the plurality of lidars based on the rotation matrix and the translation matrix to obtain the second point cloud data of the target object.

9. The calibration method according to claim 1, wherein aligning a main optical axis of the laser scanning system with the target object by rotating the laser scanning system to a second predetermined position and obtaining second point cloud data of the target object by each of the plurality of lidars in combination of calibrated first point cloud data comprises:
confirming the laser scanning system is on a same horizontal plane with the target object;
rotating the laser scanning system to make a main optical axis of the laser scanning system perpendicular to a surface of the target object, wherein the main optical axis is at a center of the laser scanning system; and
confirming distances between two positions of the laser scanning system symmetrically placed on both sides of the main optical axis and the target object are the same.

10. A calibration system configured for calibrating a laser scanning system comprising a plurality of lidars, the calibration system comprising:
a rotating device configured to carry the plurality of lidars and drive the laser scanning system to rotate;
a level spaced apart from the rotating device and configured to detect whether the plurality of lidars are on a same horizontal plane with a target object;
a laser rangefinder on the rotating device and configured to detect a distance between each of the plurality of lidars and the target object; and
an electronic device connected to the rotating device and the plurality of lidars and comprising at least one processor and a storage device storing computer-readable instructions, which when executed by the at least one processor, cause the at least one processor to:
obtain a first point cloud data of the target object from each of the plurality of lidars;
compare the first point cloud data obtained by each of the plurality of lidars and select the first point cloud data of a lidar of the plurality of lidars as reference point cloud data;
calibrate the first point cloud data obtained by each of the other lidars of the plurality of lidars based on the reference point cloud data;
obtain second point cloud data of the target object from each of the plurality of lidars in combination of calibrated first point cloud data;
fuse the second point cloud data obtained by the plurality of lidars into fused point cloud data and determine whether a scanning range of the laser scanning system has a gap or is deformed, and determining whether a total field of view of the laser scanning system equals a sum of fields of view of the plurality of lidars based on the fused point cloud data; and
terminate calibrating the laser scanning system in response to the scanning range of the laser scanning system been determined having no gap or not deformed, and the total field of view of the laser scanning system been determined equals the sum of the fields of view of the plurality of lidars.

11. The calibration system according to claim 10, wherein the at least one processor is further caused to: calculate a minimum width of the target object based on the first distance, a number of the plurality of lidars, and the field of view of each of the plurality of lidars, and an actual width of the target object is greater than or equal to the minimum width.

12. The calibration system according to claim 10, wherein the at least one processor is further caused to:
compare offsets of the first point cloud data obtained by the plurality of lidars;
compare degrees of deformation of the first point cloud data obtained by the plurality of lidars relative to the target object; and
select the first point cloud data obtained by the lidar as the reference point cloud data based on the offsets and the degrees of deformation.

13. The calibration system according to claim 10, wherein the at least one processor is further caused to:
take the reference point cloud data as a first data set;
take the first point cloud data obtained by the other lidars as second data sets, form a plurality of point pairs by matching each point of each second data set with one nearest point of the first data set; and
applying a sum of Euclidean distances between two points of each point pairs of the plurality of point pairs as an objective function to be solved, and use a singular value decomposition method to solve for a rotation matrix and a translation matrix of each of the other lidars in a case that the objective function is minimized.

14. The calibration system according to claim 13, wherein the at least one processor is further caused to:
process original point cloud data obtained by each of the plurality of lidars based on the rotation matrix and the translation matrix to obtain the second point cloud data of the target object.

15. A non-transitory storage medium having instructions stored thereon, when the instructions are executed by a processor of an electronic device, the processor is configured to perform a calibration method of calibrating a laser scanning system comprising a plurality of lidars, the method comprising:
obtaining a first point cloud data of the target object from each of the plurality of lidars;
comparing the first point cloud data obtained by each of the plurality of lidars and select the first point cloud data of a lidar of the plurality of lidars as reference point cloud data;
calibrating the first point cloud data obtained by each of the other lidars of the plurality of lidars based on the reference point cloud data;
obtaining second point cloud data of the target object from each of the plurality of lidars in combination of calibrated first point cloud data;
fusing the second point cloud data obtained by the plurality of lidars into fused point cloud data and determining whether a scanning range of the laser scanning system has a gap or is deformed, and determining whether a total field of view of the laser scanning system equals a sum of fields of view of the plurality of lidars based on the fused point cloud data; and
terminating calibrating the laser scanning system in response to the scanning range of the laser scanning system been determined having no gap or not deformed, and the total field of view of the laser scanning system been determined equals the sum of the fields of view of the plurality of lidars.

16. The non-transitory storage medium according to claim 15, wherein the method further comprises:
calculating a minimum width of the target object based on the first distance, a number of the plurality of lidars, and the field of view of each of the plurality of lidars, wherein an actual width of the target object is greater than or equal to the minimum width.

17. The non-transitory storage medium according to claim 15, wherein comparing the first point cloud data obtained by each of the plurality of lidars and select the first point cloud data of the lidar as reference point cloud data comprises:
comparing offsets of the first point cloud data obtained by the plurality of lidars;
comparing degrees of deformation of the first point cloud data obtained by the plurality of lidars relative to the target object; and
selecting the first point cloud data obtained by the lidar as the reference point cloud data based on the offsets and the degrees of deformation.

18. The non-transitory storage medium according to claim 15, wherein calibrating the first point cloud data obtained by the other lidars based on the reference point cloud data comprises:
taking the reference point cloud data as a first data set;
taking the first point cloud data obtained by the other lidars as second data sets, forming a plurality of point pairs by matching each point of each second data set with one nearest point of the first data set; and
applying a sum of Euclidean distances between two points of each point pairs of the plurality of point pairs as an objective function to be solved, and using a singular value decomposition method to solve for a rotation matrix and a translation matrix of each of the other lidars in a case that the objective function is minimized.

19. The non-transitory storage medium according to claim 18, wherein obtaining second point cloud data of the target object from each of the plurality of lidars in combination of calibrated first point cloud data comprises:
processing original point cloud data obtained by each of the plurality of lidars based on the rotation matrix and the translation matrix to obtain the second point cloud data of the target object.
